(19) United States
(12) Patent Application Publication
(10) Pub. No.: US 2007/0223809 A1
(43) Pub. Date: Sep. 27, 2007

(54) Picture display apparatus and method

(75) Inventor: Osamu Yano, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Tokyo (JP)

(21) Appl. No.: 11/717,055

(22) Filed: Mar. 13, 2007

(30) Foreign Application Priority Data
Mar. 14, 2006 (JP) 2006-069000

(51) Int. Cl. G06K 9/62

(52) U.S. Cl. 382/161

(57) ABSTRACT

A picture display apparatus which has a control-data storage section which stores signal-processing control data generated by a control-data generating section, the stored data being related to an input terminal designated by an operating section, and which reads out signal-processing control data relating to another input terminal when the designated input terminal is switched to the other input terminal. When the signal-processing control data is generated by the control data generating section, signal processing is made in accordance with the generated signal-processing control data. When signal-processing control data is read out from the control-data storage section, the signal processing is made in accordance with the read-out signal-processing control data.

### BACKGROUND OF THE INVENTION

1. Field of the Invention

The present invention relates to a picture display apparatus for displaying a picture on a display in accordance with a video signal which is selected from a plurality of input video signals and subjected to signal processing adapted for its signal form.

2. Description of the Related Art

In a picture display apparatus such as a television receiver, a plurality of input terminals are provided to input a plurality of video signals that are different or identical in signal form. By button-operating by the user at an operating portion, one input terminal of the plurality of input terminals is designated, and a video signal supplied to the one input terminal is selectively inputted, thus enabling signal processing on the input video signal in a manner corresponding to the signal form thereof. The signal processing includes, mainly, format conversion and picture-quality adjustment, which are different for each signal form of the input video signal. Accordingly, in the picture display apparatus, when an input terminal is designated at the operating portion, the signal form of the video signal inputted through the designated input terminal is identified. In accordance with a result of the identification, signal-processing control data is produced and signal processing is executed in accordance with the signal-processing control data (see JP-A-H8-129367).

Therefore, after inputting a new video signal, by a picture based on the new video signal is displayed on a display, a significant time is needed in displaying operation in the apparatus. When the user performs a switch-over operation at the operating portion in order to switch the input video signal, another picture based on the switched input video signal is not immediately available.

In order to cope with the problem, JP-A-2004-240363 discloses an apparatus for decreasing the time required to identify the form of a input video signal. In this apparatus, feature data concerning the form of each video signal is previously recorded, so that the signal form of the video signal inputted thereafter can be identified by use of the identification condition obtained by extracting the differences between those feature data and the input signal.

Meanwhile, JP-A-2005-215557 discloses an apparatus having two signal processing circuits and a picture mixing/switching section for mixing and switching between processed video signals of the two signal processing circuits, so that picture switch-over can be executed at high speed rate under control of the picture mixing/switching section.

However, the apparatus disclosed in JP-A-2004-240363 involves a problem in that there is no basic time decrease in the display switching since signal-form identification is still performed.

Meanwhile, the apparatus disclosed in JP-A-2005-215557 problematically incurs cost increase because of the need to provide the two signal processing circuits.

### SUMMARY OF THE INVENTION

It is an object of the present invention provide a picture display apparatus and method capable of displaying a picture based on a new input video signal in a short time at a comparatively low cost.

According to a first aspect of the invention, a picture display apparatus comprising: an operating section which designates one of a plurality of input terminals each of which inputs a video signal, in accordance with an operation thereon; a selector section which selectively outputs a video signal inputted to the input terminal designated by the operating section; an identification section which identifies a form of the video signal selectively outputted by the selector section; a control-data generating section which generates signal-processing control data for a video signal having the form identified by the identification section; a signal processing section which performs signal processing on the video signal selectively outputted by the selector section, in accordance with the signal-processing control data, and outputs the video signal thus processed to a display section; and a control data storage section which stores the signal-processing control data generated by the control-data generating section, the stored signal-processing control data being related to the input terminal designated by the operating section, and reads out the signal-processing control data relating to another input terminal when the designated input terminal is switched to the other input terminal by the operation section; wherein when signal-processing control data is generated by the control-data generating section, the signal processing section performs the signal processing in accordance with the generated signal-processing control data, and when signal-processing control data is read out from the control data storage section, the signal processing section performs the signal processing in accordance with the read-out signal-processing control data.

In the first aspect of the invention, signal-processing control data can be transferred from the signal-processing control data storage section to the signal processing section immediately after a switch-over operation at the operating section, so that the signal processing section can perform signal processing of the video signal supplied from the selector section in accordance with the signal-processing control data. Thus, picture display is available soon after a switch-over operation.

According to a second aspect of the invention, a picture display apparatus comprising: an operating section which designates one of a plurality of input terminals each of which inputs a video signal, in accordance with an operation on the operating section; a selector section which selectively outputs the video signal inputted to the input terminal designated by the operating section; an identification section which identifies a signal form of the video signal selectively outputted by the selector section; a signal-form data storage section which stores as signal-form data the signal form identified by the identification section, the stored signal-form data being related to the input terminal designated by the operating section, and reads out the signal-form data relating to another input terminal when the designated input terminal is switched to the other input terminal; a control-data generating section which generates signal-processing control data for a video signal having the signal form indicated by the signal-form data read-out from the signal-form data storage section; and a signal processing section which performs signal processing on the video signal selectively outputted by the selector section, in accordance with the signal-processing control data, and outputs the video signal thus processed to a display section.

In the second aspect of the invention, signal-form data is supplied from the signal-form data storage section to the signal-processing control data generating section immediately after a switch-over operation at the operating section, so that the signal-processing control data generating section can start to generate signal-processing control data which is to be supplied to the signal processing section. The signal processing section is caused to conduct signal processing on the video signal supplied from the selector section in accordance with the signal-processing control data. Thus, picture display is available soon after a switch-over operation.

According to a third aspect of the invention, a picture display apparatus comprising: an identification section which identifies a signal form of a video signal inputted to an input terminal; a control data generating section which generates signal-processing control data for a video signal having the signal form identified by the identification section; a signal processing section which performs signal processing on the video signal in accordance with the signal-processing control data and outputs the video signal thus processed to a display section; and a control data storage section which stores the signal-processing control data generated by the control data generating section; wherein, when a power supply of the apparatus is turned on, the signal processing section reads the signal-processing control data from the control data storage section and performs the signal processing in accordance with the read signal-processing control data.

In the third aspect of the invention, since signal-processing control data is read out from the control storage section when the power supply is turned on, the signal processing section can immediately perform signal processing on the input video signal in accordance with the signal-processing control data. Thus, picture display is available soon after input of an image signal.

According to a fourth aspect of the invention, a picture display apparatus comprising: an identification section which identifies the signal form of a video signal inputted to an input terminal; a signal-form data storage section which stores, as signal-form data, the signal form identified by the identification section; a control data generating section which generates signal-processing control data for a video signal having the signal form identified by the identification section; and a signal processing section which performs signal processing on the video signal in accordance with the signal-processing control data and outputs the video signal thus processed to a display section; wherein, when a power supply of the apparatus is turned on, the control data generating section reads the signal-form data from the signal-form data storage section and generates the signal-processing control data for a video signal having the signal form indicated by the read signal-form data, and the signal processing section performs the signal processing in accordance with the signal-processing control data.

In the fourth aspect of the invention, because a signal-form data signal is read out from the signal-form data storage section when a power supply is turned on, and signal-processing control data for the video signal having a signal form indicated by the signal-form data is generated, the signal processing section can immediately perform signal processing on the input video signal in accordance with the generated signal-processing control data. Thus, picture display is available soon after an image signal is inputted.

According to a fifth aspect of the invention, a picture display method comprising: an operating step of designating one of a plurality of input terminals each of which inputs a video signal, in accordance with an operation thereon; a selecting step of selectively outputting the video signal inputted to the input terminal designated in the operating step; an identification step of identifying the signal form of the video signal selectively outputted in the selecting step; a control-data generating step of generating signal-processing control data for a video signal having the form identified in the identification step; a signal processing step of performing signal processing on the video signal selectively outputted by the selecting step in accordance with the signal-processing control data and outputting the video signal thus processed to a display section; and a control data storage step of storing the signal-processing control data generated in the control-data generating step into a storage section, the stored signal-processing control data being related to the input terminal designated in the operating step, and reading out the signal-processing control data relating to another input terminal from the storage section when the designated input terminal is switched to the other input terminal in the operating step; wherein, when the signal-processing control data is generated in the control-data generating step, the signal processing is performed in accordance with the generated signal-processing control data in the signal processing step performs, and when the signal-processing control data is read out in the control data storage step, the signal processing is performed in accordance with the read-out signal-processing control data in the signal processing step.

In the fifth aspect of the invention, signal-processing control data stored in the data storage step is outputted immediately after a switch-over operation in the operation step. In the signal processing step, signal processing can be done on the video signal which has been selectively outputted, in accordance with the signal-processing control data. Thus, picture display is available soon after a switch-over operation.

According to a sixth aspect of the invention, a picture display method comprising: an operating step of designating one of a plurality of input terminals each of which inputs a video signal, in accordance with an operation thereon; a selecting step of selectively outputting the video signal inputted to the input terminal designated in the operating step; an identification step of identifying the signal form of the video signal selectively outputted in the selecting step; a signal-form data storage step of storing as signal-form data the signal form identified in the identification step into a storage section, the stored signal-form data being relating to the input terminal designated in the operating step, and reading out from the storage section the signal-form data relating to another input terminal when the designated input terminal is switched to the other input terminal in the operating step; a control-data generating step of generating signal-processing control data for the video signal in the form indicated by the signal-form data read-out from the signal-form data storage step; and a signal processing step of performing signal processing on the video signal selectively outputted in the selecting step, in accordance with the control data, and outputting the video signal thus processed to a display section.

In the sixth aspect of the invention, signal-form data is outputted in the signal-form data storage step immediately after the switch-over operation in the operating step, and signal-processing control data generation is started and signal-processing control data is outputted in the signal-process data generating step. In the signal processing step, signal processing can be made on the video signal selectively outputted, in accordance with the signal-processing control data. Thus, picture display is available soon after a switch-over operation.

According to a seventh aspect of the invention, a picture display method comprising: an identification step of identifying the signal form of a video signal inputted to an input terminal; a control data generating step of generating signal-processing control data for a video signal in the signal form identified in the identification step; a signal processing step of performing signal processing on the video signal in accordance with the signal-processing control data and outputting the video signal thus processed to a display section; and a control data storage step of storing the signal-processing control data generated in the control data generating step into a storage section; wherein, when a power supply is turned on, the signal-processing control data is read out from the storage section and the signal processing is performed in accordance with the read-out signal-processing control data in the signal processing step.

In the seventh aspect of the invention, since signal-processing control data is outputted upon turning on a power supply in the control storage step, signal processing on the input video signal can be immediately performed in accordance with the signal-processing control data in the signal processing step. Thus, picture display is available soon after a switch-over operation.

According to an eighth aspect of the invention, a picture display method comprising: an identification step of identifying the signal form of a video signal inputted to an input terminal; a signal-form data storage step of storing as signal-form data the signal form identified in the identification step into a storage section; a control data generating step of generating signal-processing control data for a video signal in the signal form identified in the identification step; and a signal processing step of performing signal processing on the video signal in accordance with the signal-processing control data and outputting the video signal thus processed to a display section; wherein, when a power supply is turned on, the signal-form data is read out from the storage section and the signal-processing control data for a video signal having the signal form indicated by the read-out signal-form data, in the control data generating step, and the signal processing is performed in accordance with the signal-processing control data in the signal processing step.

In the eighth aspect of the invention, a signal-form data signal is read out from the storage section when power supply is turned on. Furthermore, signal-processing control data for a video signal having the signal form indicated by the signal-form data is generated. Accordingly, in the signal processing step, signal processing can be immediately performed on the input video signal in accordance with the signal-processing control data. Thus, picture display is available soon after a switch-over operation.

### BRIEF DESCRIPTION OF THE DRAWINGS

FIG. 1 is a block diagram showing an embodiment of the present invention;

FIG. 2 is a block diagram showing a specific configuration of a signal processing section in the apparatus of FIG. 1;

FIG. 3 is a flowchart showing a switch-over operation of the apparatus of FIG. 1;

FIGS. 4A and 4B are figures showing the time required for each step of the switch-over operation of the apparatus of FIG. 1;

FIG. 5 is a flowchart showing an operation when power supply of the apparatus of FIG. 1, which has only a single input terminal, is turned on.

FIG. 6 is a figure showing the time required for each step when power supply is turned on in FIG. 5;

FIG. 7 is a block diagram showing an embodiment of the invention;

FIG. 8 is a flowchart showing a switch-over operation of the apparatus of FIG. 7;

FIG. 9 is a figure showing the time required for each step of the switch-over operation of the apparatus of FIG. 7;

FIG. 10 is a flowchart showing the operation steps when power supply of the apparatus of FIG. 7, which has only a single input terminal, is turned on;

FIG. 11 is a figure showing a time required for each operation step when power supply is turned on in the FIG. 10; and

FIG. 12 is a block diagram showing a picture display apparatus having two signal processing systems to which the invention is applied.

### DETAILED DESCRIPTION OF THE INVENTION

With reference to the drawings, embodiments of the present invention will now be described in detail.

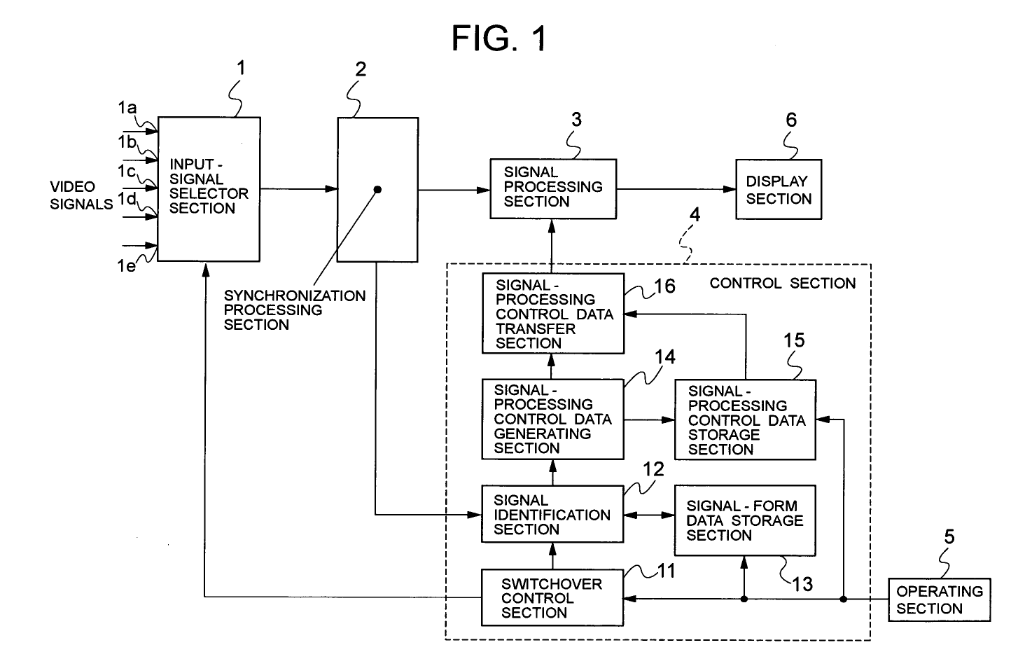

FIG. 1 shows a picture display apparatus according to the present invention. The picture display apparatus includes an input-signal selector section 1, a synchronization processing section 2, a signal processing section 3, a control section 4, an operating section 5 and a display section (monitor) 6. The control section 4 further has a switch-over control section 11, a signal identification section 12, a signal-form data storage section 13, a signal-processing control data generating section 14, a signal-processing control data storage section 15 and a signal-processing control data transfer section 16.

The input-signal selector section 1 has a plurality of input terminals 1a-1e for inputting a plurality of video signals separately. The plurality of video signals include a composite signal, an RGB video signal and a component video signal, which are supplied to any of the input terminals 1a-1e. The input-signal selector section 1 selects one of the plurality of input terminals 1a-1e, in accordance with a switch-over control signal supplied from the switch-over control section 3. Thus, one of the plurality of input video signals is selectively outputted.

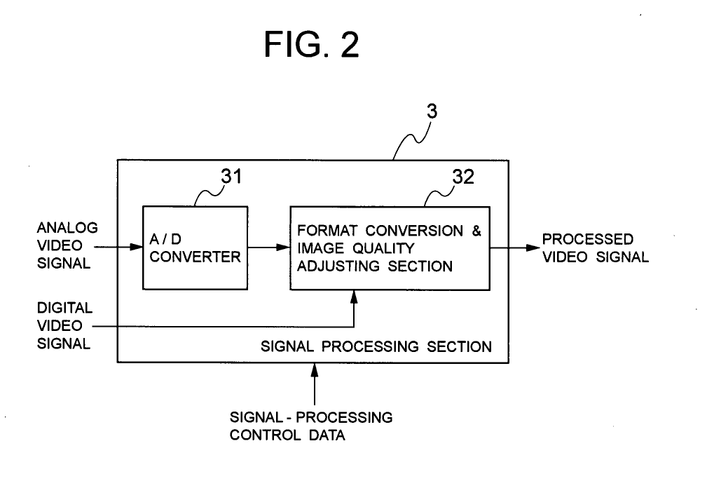

The synchronization processing section 2 clamps the video signal selectively outputted from the input-signal selector section 1 to supply it to the signal processing section 3 and detects a synchronization signal of the video signal. The signal processing section 3 includes an A/D converter 31 and a format change & image quality adjusting section 32, as shown in FIG. 2. When the input video signal is an analog signal, the A/D converter 31 converts the input video signal into a digital video signal. When the input video signal is a digital signal, the digital video signal is supplied, as it is, to the format change & image quality adjusting section 32. The format change & image quality adjusting section 32 converts the format of the digital video signal outputted from the A/D converter 31 into a particular form of video signal (e.g. RGB video signal) and makes a picture-quality adjustment on the converted video signal. The format conversion includes IP conversion (interlace progressive conversion) and magnification change. The picture-quality adjustment includes inverse-gamma conversion, contrast adjustment and brightness adjustment.

To the control section 4 is connected to the input-signal selector section 1, the synchronization processing section 2, the signal processing section 3 and the operating section 5. The operating section 5 has a plurality of buttons (not shown) for selectively designating one of the plurality of input terminals 1a-1e of the input-signal selector section 1. By operating any one of the plurality of buttons, a switch-over operation is effected. Accordingly, the plurality of buttons correspond respectively to the plurality of input terminals 1a-1e of the input-signal selector section 1. Alternatively, there may be only one switching button, configured to designate a different one of the plurality of input terminals 1a-1e in a predetermined order every time it is operated.

The switch-over control section 11 outputs a switch-over control signal to the input-signal selector section 1, in response to the switch-over operation of the operating section 5. The switch-over control signal indicates the input terminal to be selected, i.e. the format of the input video signal. The signal identification section 12 identifies the type of the video signal being selected, i.e. signal format, in accordance with the level of the synchronization signal supplied from the synchronization processing section 2. The signal identification section 12 supplies signal-form data indicating the signal format identified to the signal-form data storage section 13 and the signal-processing control data generating section 14. The signal-form data storage section 13 stores the signal-form data supplied from the signal identification section 12. The signal-form data storage section 13 selectively supplies the stored signal-form data to the signal identification section 12, in response to the switch-over operation of the operating section 5.

The signal-processing control data generating section 14 produces signal-processing control data in accordance with the signal-form data supplied from the signal identification section 12, and supplies the signal-processing control data to the signal-processing control data storage section 15 and the signal-processing control data transfer section 16. The signal-processing control data is control data for the signal processing section 3 to perform the format conversion such as IP conversion and magnification-change, and the picture-quality adjustment such as inverse-gamma conversion, contrast adjustment and brightness adjustment. The signal-processing control data storage section 15 stores the signal-processing control data supplied from the signal-processing control data generating section 14. The signal-processing control data is stored relating to the input terminal that has been designated in the switch-over operation the operating section 5. Namely, the signal-processing control data is stored by having a corresponding relationship with the format of the input video signal. Meanwhile, the signal-processing control data storage section 15 selectively reads out the signal-processing control data in response to the switch-over operation of the operating section 5 and supplies the read data to the signal-processing control data transfer section 16. The signal-processing control data transfer section 16 transfers the signal-processing control data supplied from the signal-processing control data generating section 14 or the signal-processing control data storage section 15, to the signal processing section 3.

The display section 6 has a display such as a liquid-crystal display panel, to display a picture on the display in accordance with the video signal outputted from the signal processing section 3.

In the picture display apparatus thus configured, the switch-over operation is made by the user on the operating section 5 to switch an input video signal. When the switch-over operation is made, picture mute is immediately applied to the display section 5 in accordance with to a command from the control section 5 (step S1). The picture mute is a state in which no picture is displayed on the display of the display section 6.

The switch-over control section 11 outputs a switch-over control signal to the input-signal selector section 1, in accordance with the switch-over operation of the operating section 5 (step S2). The switch-over control signal is supplied to the input-signal selector section 1 and the input-signal selector section 1 selectively outputs the video signal of the input terminal indicated by the switch-over control signal (step S3). The video signal outputted from the input-signal selector section 1 is supplied to the synchronization processing section 2 where it is subjected to synchronization processing (Step S4). Namely, by the synchronization processing, the video signal is clamped to adjust the signal level and then the clamped video signal is supplied to the signal processing section 3, and a synchronization signal of the video signal is detected.

Along with the operations of the steps S2-S4, the operation of the steps S5, S6 are performed as in the following manner. The signal-processing control data storage section 15 reads out the signal-processing control data relating to the input terminal designated by the switch-over operation of the operating section 5, and the signal-form data storage section 13 reads out the signal-form data relating to the input terminal designated by the switch-over operation the operating section 5 (step S5). The signal-processing control data thus read out is supplied to the signal-processing control data transfer section 16 while the signal-form data read out is supplied to the signal identification section 12. The signal-processing control data transfer section 16 transfers the supplied signal-processing control data to the signal processing section 3 (step S6).

The signal processing section 3 starts signal processing of the video signal in accordance with the signal-processing control data. The display section 5 is released from the picture mute state to display a picture (step S7). Namely, in the signal processing section 3, signal processing of the video signal supplied from the synchronization processing section 2 is performed in accordance with the signal-processing control data that is held. The processed video signal is supplied to the display section 5 where a picture is displayed in accordance with the video signal.

Thereafter, the signal identification section 12 identifies the format of the input video signal in accordance with the synchronization signal supplied from the synchronization processing circuit 2 (step S8) and compares between the signal-form data as a result of the identification and the signal-form data read out from the signal-form data storage section 13 (step S9). If the result is in a match, this means that the format of the video signal selected by the input-signal selector section 1 is equal to the format indicated by the signal-form data read out from the signal-form data storage section 13. In this case, current display is continued (step S10).

On the other hand, in the case the result are not in a match, the signal-processing control data generating section 14 produces signal-processing control data in accordance with the signal-form data newly supplied from the signal identification section 12 (step S11). The signal-processing control data is transferred to the signal processing section 3 through the signal-processing control data transfer section 16 (step S12). Accordingly, because the signal processing section 3 processes the video signal in accordance with the new signal-processing control data, the display section 6 can obtain a proper picture display state corresponding to the format of the video signal selected by the input-signal selector section 1.

Additionally, at the step S11, the signal form identified by the signal identification section 12 is stored, as signal-form data, in the signal-form data storage section 13, relating to the input terminal designated by the operating section 5. Meanwhile, at the step S12, the signal-processing control data is supplied to the signal-processing control data storage section 15 which stores this data relating to the input terminal designated at the operating section 5.

Furthermore, after executing the step S10 or S12, the process may return to the step S8 to repetitively execute the step S8 and the subsequent steps.

In the picture display apparatus of the invention, the signal-processing control data stored in the signal-processing control data storage section 15 is transferred to the signal processing section 3 immediately after a user's switch-over operation on the operating section 5. Concurrently, the input-signal selector section 1 performs a selecting operation while the synchronization processing section 2 performs synchronization processing. Therefore, proper picture display is available in a short time after the switch-over operation. Particularly, when the forms of video signals supplied to the respective input terminals are fixed, desired picture display is available in a brief time without any problem. Even when the picture display does not correspond to the format of the video signal selected by the input-signal selector section 1, the desired picture display is automatically obtained soon. In addition, because only one signal processing circuit system is required, decrease of the time required for the switch-over of picture display is realized at low cost.

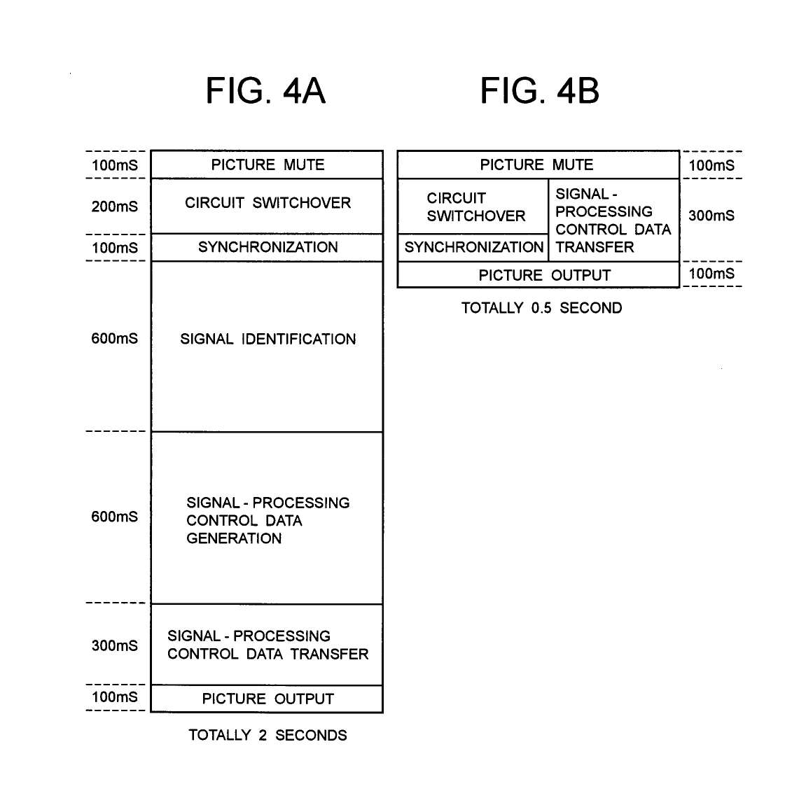

FIG. 4A shows the time required for each operation where the signal-processing control data generating section 14 produces signal-processing control data and transfers it to the signal processing section 3, in accordance with the signal-form data supplied from the signal identification section 12 without using the signal-processing control data storage section 15. The total time in this case, i.e. time required to make a picture display after a switch-over on the operating section 5, is approximately 2 seconds. FIG. 4B shows the time required for each operation where the signal-processing control data storage section 15 is used, the signal-processing control data supplied from the signal-processing control data storage section 15 being transferred to the signal processing section 3. In this case, it takes approximately 0.5 second to make a picture display after a switch-over is done on the operating section 5.

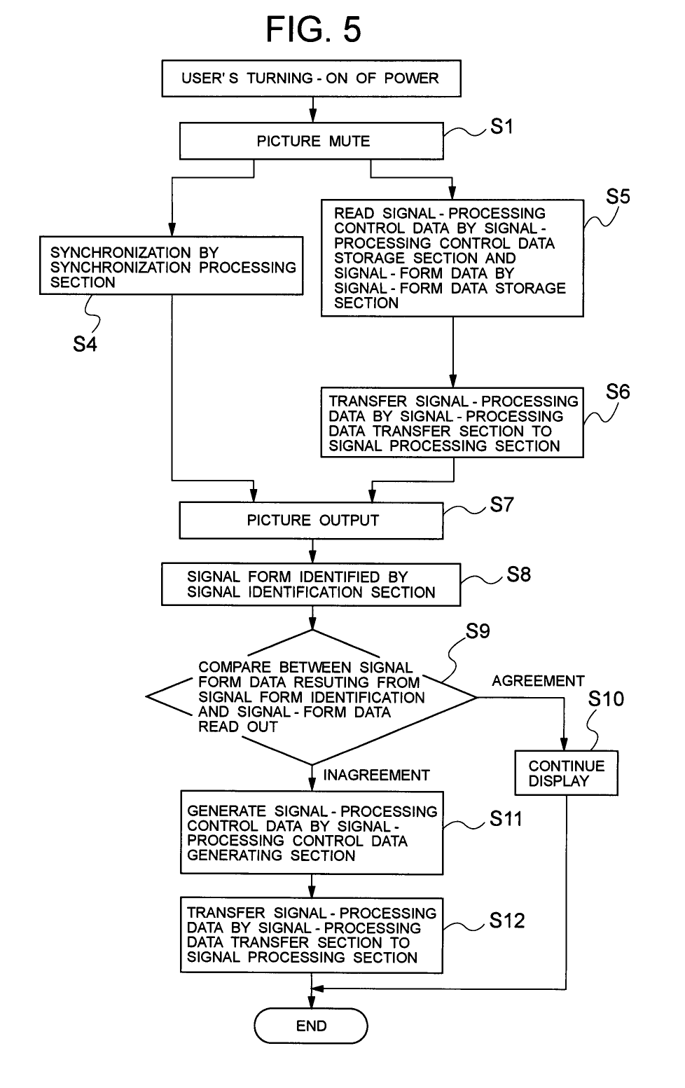

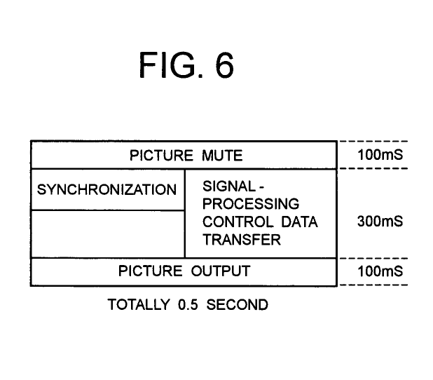

Although the input-signal selector section 1 is provided in the picture display apparatus of FIG. 1, the invention is applicable also to an apparatus arranged for inputting a video signal with a single input terminal without providing the input-signal selector section 1. For example, as shown in FIG. 5, when the apparatus is powered on by turning on a power-supply switch (not shown) for the apparatus, the synchronization processing section 2 performs the synchronization processing, including a synchronization detection, on a video signal. Simultaneously therewith, the signal-processing control data transfer section 16 transfers the signal-processing control data outputted from the signal-processing control data storage section 15 to the signal processing section 3. When a synchronization signal is detected in the synchronization process and the signal processing data is transferred to the signal processing section 3, picture display is made. Also in this case, it takes approximately 0.5 second to make the picture display after turning on the power-supply switch, as shown in FIG. 6.

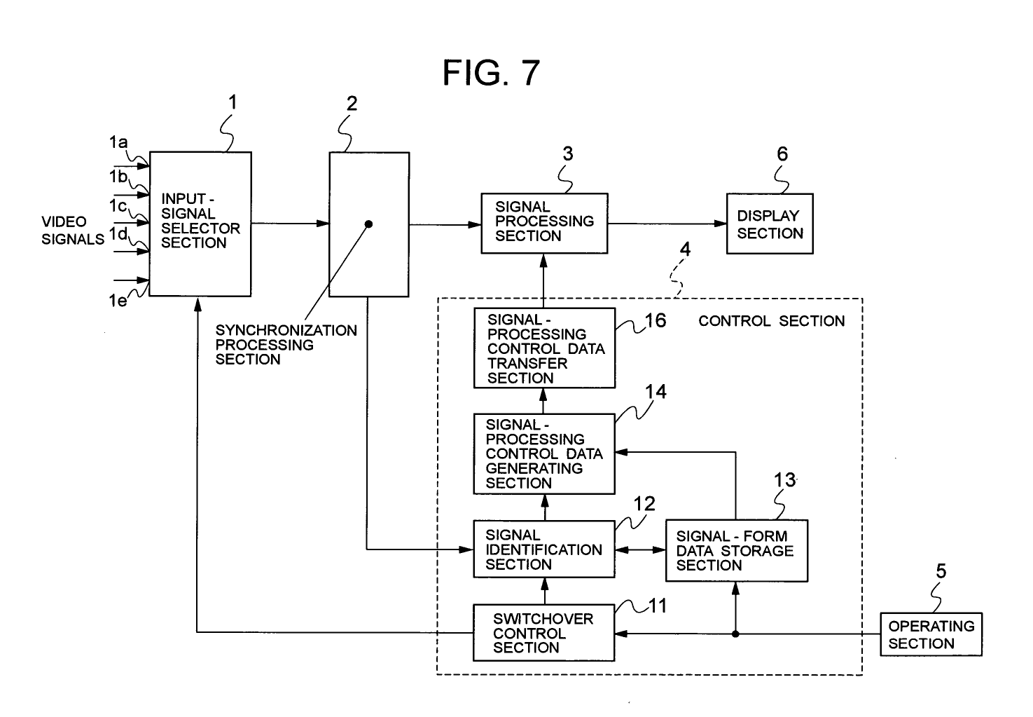

FIG. 7 shows a picture display apparatus as another embodiment of the invention. In the picture display apparatus, a control section 4 includes a switch-over control section 11, a signal identification section 12, a signal-form data storage section 13, a signal-processing control data generating section 14 and a signal-processing control data transfer section 16. Thus, this apparatus is similar to the FIG. 1 apparatus except for the absence of the signal-processing control data storage section 15 in FIG. 1.

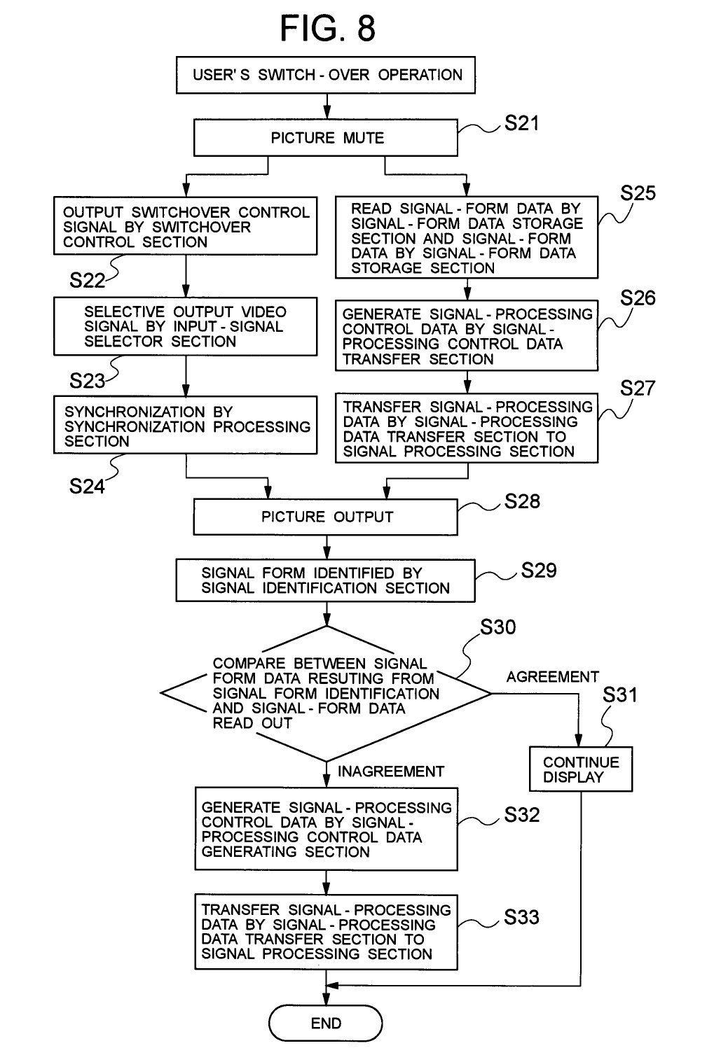

In the picture display apparatus of FIG. 7, when the user performs a switch-over operation on the operating section 5, as shown in FIG. 8, picture mute is immediately applied to the display section 5 in accordance with a command from the control section 5 (step S21).

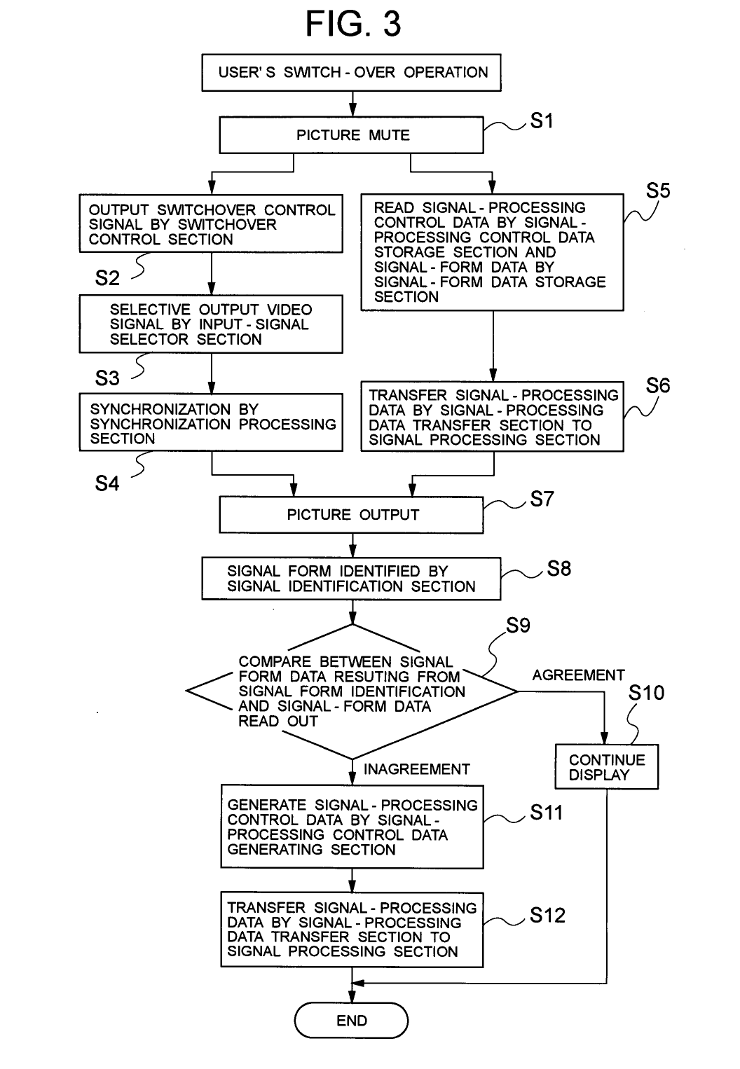

The switch-over control section 11 outputs a switch-over control signal to the input-signal selector section 1, in accordance with the switch-over operation on the operating section (step S22). The switch-over control signal is supplied to the input-signal selector section 1, so that the input-signal selector section 1 can selectively output the video signal of the input terminal indicated by the switch-over control signal (step S23). The video signal outputted from the input-signal selector section 1 is supplied to the synchronization processing section 2 in which synchronization processing is performed (Step S24). The steps S21-S24 are identical to the steps S1-S4 of FIG. 3.

Concurrently with the operation of the steps S22-S24, the operation of steps S25-S27 are performed as in the following manner. The signal-form data storage section 13 reads out the signal-form data relating to the input terminal which has been designated by the switch-over operation on the operating section 5 (step S25). The read-out signal-form data is supplied to the signal identification section 12 and the signal-processing control data generating section 14, so that the signal-processing control data generating section 14 can generate signal-processing control data in accordance with the supplied signal-form data (step S26). The generated signal-processing control data is supplied to the signal-processing control data transfer section 16, so that the signal-processing control data transfer section 16 can transfer the supplied signal-processing control data to the signal processing section 3 (step S27).

The signal processing section 3 starts signal processing of the video signal in accordance with the signal-processing control data. This releases the display section 5 from the picture mute state, thus allowing for picture output on the display (step S28). Namely, signal processing is performed in the signal processing section 3 on the video signal supplied from the synchronization processing section 2, in accordance with the signal-processing control data. The video signal processed is supplied to the display section 5 where a picture is displayed in accordance with the video signal.

Thereafter, the operation of step S29 and the subsequent is executed. The steps S29-S33 are identical to the steps S8-S12 of FIG. 3.

Incidentally, at the step S32, the signal form identified by the signal identification section 12 is stored, as signal-form data, in the signal-form data storage section 13, designating that this data corresponds to the input terminal designated at the operating section 5. Meanwhile, after executing the step S31 or S33, the process may return to the step S29 to repetitively execute the step S29 and the subsequent steps.

In the picture display apparatus of the invention, the signal-processing control data generating section 14 starts to generate signal-processing control data immediately after a user's switch-over operation on the operating section. Concurrently therewith, the input-signal selector section 1 performs a selecting operation while the synchronization processing section 2 makes synchronization processing. Therefore, picture display is available soon after the switch-over operation. When the picture on display does not correspond to the format of the video signal selected by the input-signal selector section 1, switch-over is automatically made to the proper picture display in due course.

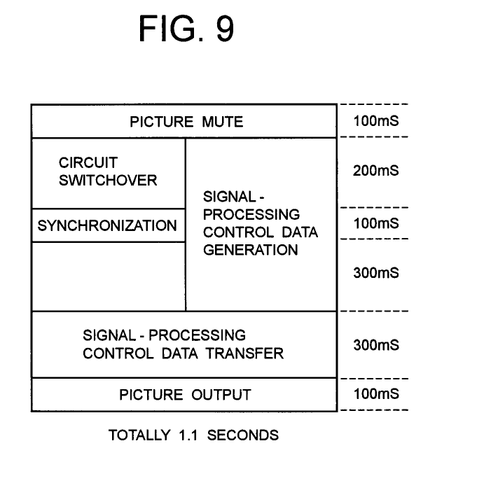

FIG. 9 shows the time required for each operation of the picture display apparatus of FIG. 7, where signal-processing control data is generated and transferred to the signal processing section 3, in accordance with a signal-form data obtained from the signal-form data storage section 13. In this case, it takes about 1.1 seconds to make a picture display after a switch-over of the operating section 5.

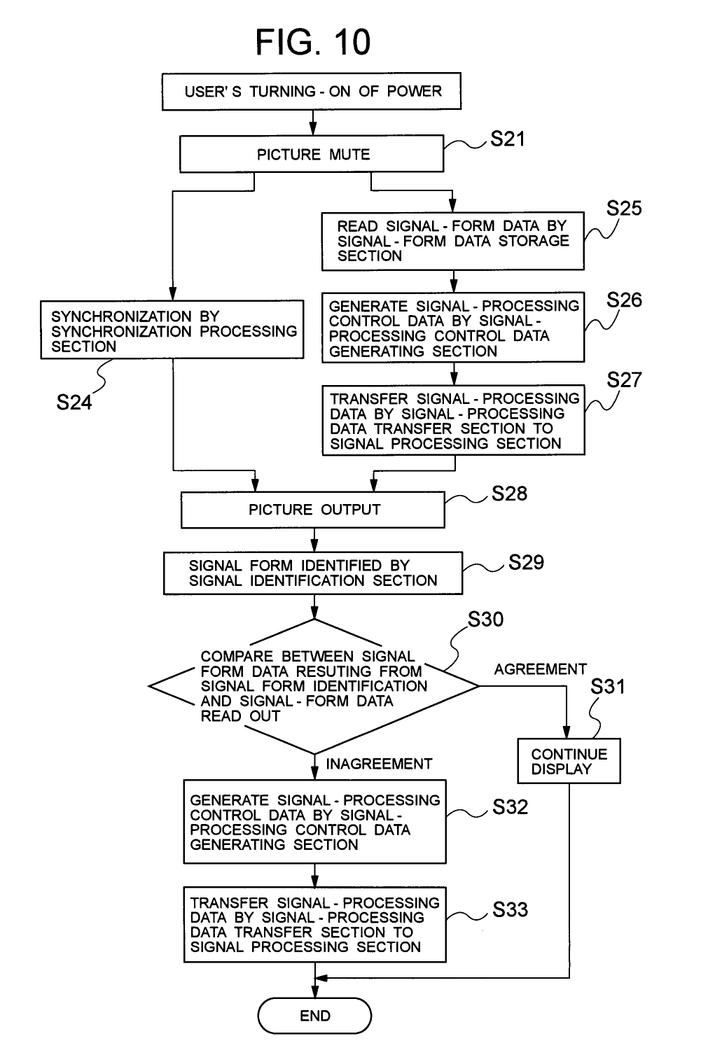

Although the input-signal selector section 1 is provided in the picture display apparatus of FIG. 7, the invention is applicable also to an apparatus arranged for inputting a video signal through a single input terminal without providing an input-signal selector section 1. For example, as shown in FIG. 10, when the apparatus is powered on by turning on a power-supply switch (not shown) for the apparatus, the synchronization processing section 2 performs synchronization processing, including synchronization detection, on the video signal. Simultaneously therewith, signal-processing control data is generated in accordance with the signal-form data obtained from the signal-form data storage section 13, which is then transferred to the signal processing section 3 by the signal-processing control data transfer section 16. When a synchronization signal is detected in the synchronization process and the signal processing data is transferred to the signal processing section 3, picture display is made. In also this case, it takes about 1.1 seconds to make a picture display after turning on the power-supply switch.

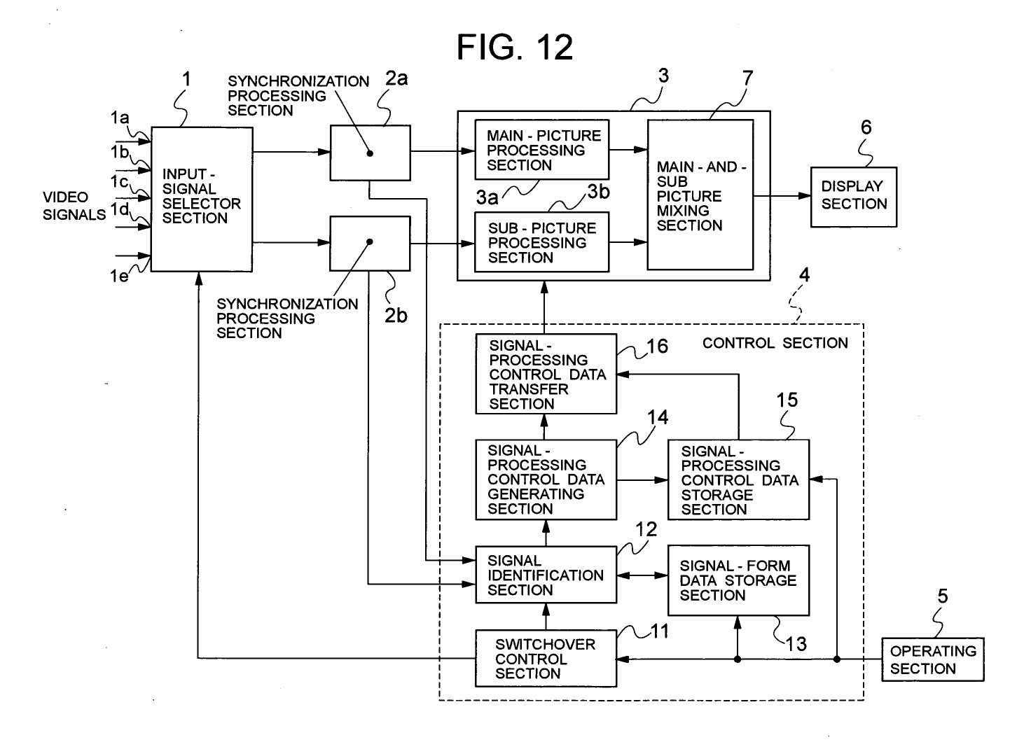

FIG. 12 shows a configuration where the invention is applied to a picture display apparatus having two signal processing systems. The picture display apparatus includes an input-signal selector section 1, synchronization processing sections 2a, 2b, a signal processing section 3, a control section 4, an operating section 5 and a display section 6. The signal processing section 3 has a main-picture processing section 3a, a sub-picture processing section 3b and a main-and-sub picture mixing section 7. The synchronization processing section 2a and the main-picture processing section 3a constitute a first signal processing section while the synchronization processing section 2b and the sub-picture processing section 3b constitute a second signal processing section. The input-signal selector section 1 selectively supplies one of a plurality of input video signals to the first signal processing section, and that one or another of the plurality of input video signals to the second signal processing system. The synchronization processing sections 2a, 2b each operate in the same way as the FIG. 1 synchronization processing section 2. The main-picture processing section 3a and the sub-picture processing section 3b each operate in the same way as the signal processing section 2 of FIG. 1. The main-and-sub picture mixing section 7 outputs a mixed signal of the processed video signals outputted from the main-picture processing section 3a and sub-picture 3b or output one of these signals.

The control section 4 has a switch-over control section 11, a signal identification section 12, a signal-form data storage section 13, a signal-processing control data generating section 14, a signal-processing control data storage section 15 and a signal-processing control data transfer section 16, the same as the FIG. 1 configuration. The signal-processing control data is supplied selectively to the main-picture or sub-picture processing sections 3a, 3b, or both.

When a user performs a switch-over operation on the operating section 5 so as to switch the input video signal over to the first signal processing system, the switch-over control section 11 outputs a switch-over control signal to the input-signal selector section 1 in accordance with this switch-over operation on the operating section 5. As a result, the input-signal selector section 1 selectively outputs the video signal of the input terminal indicated by the switch-over control signal to the synchronization processing section 2a. The signal-processing control data storage section 15 reads out the signal-processing control data corresponding to the input terminal designated by the switch-over operation on the operating section 5. The signal-processing control data thus read out is transferred to the main-picture processing section 3a through the signal-processing control data transfer section 16. Likewise, when a user makes a switch-over operation to the operating section 5 to switch the input video signal over to the second signal processing system, the switch-over control section 11 outputs a switch-over control signal to the input-signal selector section 1 in accordance with this switch-over operation of the operating section 5. As a result, the input-signal selector section 1 selectively outputs the video signal of the input terminal indicated by the switch-over control signal to the synchronization processing section 2b. The signal-processing control data storage section 15 reads out the signal-processing control data corresponding to the input terminal designated by the switch-over operation on the operating section 5. The signal-processing control data thus read out is transferred to the sub-picture processing section 3b through the signal-processing control data transfer section 16.

In the FIG. 12 picture display apparatus, the following operation is available for so-called two-picture display that makes a simultaneous display of a main-picture based on the video signal of from the first signal processing system and a sub-picture based on the video signal from the second signal processing system. Namely, when the input video signal is switched over to the first signal processing system, then the main picture is chosen from between the two pictures and displayed in a brief time. Conversely, when the input video signal is switched over to the second signal processing system, then the sub-picture is chosen from between the two pictures and displayed in a brief time.

Incidentally, FIG. 12 shows an example of the FIG. 1 control section applied to the picture display apparatus having two signal processing systems, but the FIG. 7 control section is also applicable to such a picture display apparatus having two signal processing systems.

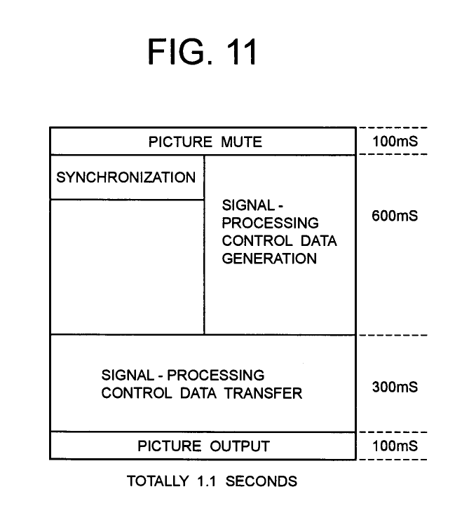

Further, in FIGS. 4A, 4B, 6, 9 and 11, the time required for each operation is shown as an example, and the invention is not limited to these times.

As described above, the invention allows for picture switch-over for display in a short time at comparatively low cost.

This application is based on Japanese Patent Application No. 2006-069000 which is hereby incorporated by reference.

What is claimed is:

1. A picture display apparatus comprising:
an operating section which designates one of a plurality of input terminals each of which inputs a video signal, in accordance with an operation thereon;
a selector section which selectively outputs a video signal inputted to the input terminal designated by the operating section;
an identification section which identifies a form of the video signal selectively outputted by the selector section;
a control-data generating section which generates signal-processing control data for a video signal having the form identified by the identification section;
a signal processing section which performs signal processing on the video signal selectively outputted by the selector section, in accordance with the signal-processing control data, and outputs the video signal thus processed to a display section; and
a control data storage section which stores the signal-processing control data generated by the control-data generating section, the stored signal-processing control data being related to the input terminal designated by the operating section, and reads out the signal-processing control data relating to another input terminal when the designated input terminal is switched to the other input terminal by the operation section;
wherein when signal-processing control data is generated by the control-data generating section, the signal processing section performs the signal processing in accordance with the generated signal-processing control data, and when signal-processing control data is read out from the control data storage section, the signal processing section performs the signal processing in accordance with the read-out signal-processing control data.

2. A picture display apparatus according to claim 1, further comprising a signal-form data storage section which stores as signal-form data the signal form identified by the identification section, the stored signal-form data being related to the input terminal designated by the operating section, and reads out signal-form data relating to the other input terminal when the designated input terminal is switched to the other input terminal by the operation section,
wherein the identification section includes a comparator which compares between the signal form of the video signal selectively outputted by the selector section and the signal form indicated by the signal-form data read-out from the signal-form data storage section, and
the control-data generating section generates the signal-processing control data for a video signal having the signal form identified by the identification section when the comparison by the comparator indicates a mismatching result.

3. A picture display apparatus according to claim 1, further comprising a control data transfer section which transfers, when the control data is generated by the control data generating section, the generated control data to the signal processing section and transfers, when the control data is read out from the control data storage section, the read-out control data to the signal processing section.

4. A picture display apparatus comprising:
an operating section which designates one of a plurality of input terminals each of which inputs a video signal, in accordance with an operation on the operating section;
a selector section which selectively outputs the video signal inputted to the input terminal designated by the operating section;
an identification section which identifies a signal form of the video signal selectively outputted by the selector section;
a signal-form data storage section which stores as signal-form data the signal form identified by the identification section, the stored signal-form data being related to the input terminal designated by the operating section, and reads out the signal-form data relating to another input terminal when the designated input terminal is switched to the other input terminal;
a control-data generating section which generates signal-processing control data for a video signal having the signal form indicated by the signal-form data read-out from the signal-form data storage section; and
a signal processing section which performs signal processing on the video signal selectively outputted by the selector section, in accordance with the signal-processing control data, and outputs the video signal thus processed to a display section.

5. A picture display apparatus according to claim 4, wherein the identification section includes a comparator which compares between the signal form of the video signal selectively outputted by the selector section and the signal form indicated by the signal-form data read-out from the signal-form data storage section, and
the control-data generating section generates the signal-processing control data for a video signal having the signal form identified by the identification section when the comparison by the comparator indicates a mismatching result.

6. A picture display apparatus according to claim 4, further comprising a control data transfer section which transfers, when the control data is generated by the control data generating section, the generated control data to the signal processing section.

7. A picture display apparatus comprising:
an identification section which identifies a signal form of a video signal inputted to an input terminal;
a control data generating section which generates signal-processing control data for a video signal having the signal form identified by the identification section;
a signal processing section which performs signal processing on the video signal in accordance with the signal-processing control data and outputs the video signal thus processed to a display section; and
a control data storage section which stores the signal-processing control data generated by the control data generating section;
wherein, when a power supply of the apparatus is turned on, the signal processing section reads the signal-processing control data from the control data storage section and performs the signal processing in accordance with the read signal-processing control data.

8. A picture display apparatus comprising:
an identification section which identifies the signal form of a video signal inputted to an input terminal;
a signal-form data storage section which stores, as signal-form data, the signal form identified by the identification section;
a control data generating section which generates signal-processing control data for a video signal having the signal form identified by the identification section; and
a signal processing section which performs signal processing on the video signal in accordance with the signal-processing control data and outputs the video signal thus processed to a display section;
wherein, when a power supply of the apparatus is turned on, the control data generating section reads the signal-form data from the signal-form data storage section and generates the signal-processing control data for a video signal having the signal form indicated by the read signal-form data, and the signal processing section performs the signal processing in accordance with the signal-processing control data.

9. A picture display method comprising:
an operating step of designating one of a plurality of input terminals each of which inputs a video signal, in accordance with an operation thereon;
a selecting step of selectively outputting the video signal inputted to the input terminal designated in the operating step;
an identification step of identifying the signal form of the video signal selectively outputted in the selecting step;
a control-data generating step of generating signal-processing control data for a video signal having the form identified in the identification step;
a signal processing step of performing signal processing on the video signal selectively outputted by the selecting step in accordance with the signal-processing control data and outputting the video signal thus processed to a display section; and
a control data storage step of storing the signal-processing control data generated in the control-data generating step into a storage section, the stored signal-processing control data being related to the input terminal designated in the operating step, and reading out the signal-processing control data relating to another input terminal from the storage section when the designated input terminal is switched to the other input terminal in the operating step;
wherein, when the signal-processing control data is generated in the control-data generating step, the signal processing is performed in accordance with the generated signal-processing control data in the signal processing step performs, and when the signal-processing control data is read out in the control data storage step, the signal processing is performed in accordance with the read-out signal-processing control data in the signal processing step.

10. A picture display method comprising:
an operating step of designating one of a plurality of input terminals each of which inputs a video signal, in accordance with an operation thereon;
a selecting step of selectively outputting the video signal inputted to the input terminal designated in the operating step;
an identification step of identifying the signal form of the video signal selectively outputted in the selecting step;
a signal-form data storage step of storing as signal-form data the signal form identified in the identification step into a storage section, the stored signal-form data being relating to the input terminal designated in the operating step, and reading out from the storage section the signal-form data relating to another input terminal when the designated input terminal is switched to the other input terminal in the operating step;
a control-data generating step of generating signal-processing control data for the video signal in the form indicated by the signal-form data read-out from the signal-form data storage step; and
a signal processing step of performing signal processing on the video signal selectively outputted in the selecting step, in accordance with the control data, and outputting the video signal thus processed to a display section.

11. A picture display method comprising:
an identification step of identifying the signal form of a video signal inputted to an input terminal;
a control data generating step of generating signal-processing control data for a video signal in the signal form identified in the identification step;
a signal processing step of performing signal processing on the video signal in accordance with the signal-processing control data and outputting the video signal thus processed to a display section; and
a control data storage step of storing the signal-processing control data generated in the control data generating step into a storage section;
wherein, when a power supply is turned on, the signal-processing control data is read out from the storage section and the signal processing is performed in accordance with the read-out signal-processing control data in the signal processing step.

12. A picture display method comprising:
an identification step of identifying the signal form of a video signal inputted to an input terminal;
a signal-form data storage step of storing as signal-form data the signal form identified in the identification step into a storage section;
a control data generating step of generating signal-processing control data for a video signal in the signal form identified in the identification step; and
a signal processing step of performing signal processing on the video signal in accordance with the signal-processing control data and outputting the video signal thus processed to a display section;
wherein, when a power supply is turned on, the signal-form data is read out from the storage section and the signal-processing control data for a video signal having the signal form indicated by the read-out signal-form data, in the control data generating step, and the signal processing is performed in accordance with the signal-processing control data in the signal processing step.
